(19) United States
(12) Patent Application Publication
(10) Pub. No.: US 2019/0272071 A1
(43) Pub. Date: Sep. 5, 2019

(54) AUTOMATIC GENERATION OF A HIERARCHICALLY LAYERED COLLABORATIVELY EDITED DOCUMENT VIEW

(71) Applicant: International Business Machines Corporation, Armonk, NY (US)

(72) Inventors: Jeremy A. Greenberger, San Jose, CA (US); Zachary M. Greenberger, Raleigh, NC (US); Trudy L. Hewitt, Cary, NC (US); Jana H. Jenkins, Raleigh, NC (US); Fang Lu, Billerica, MA (US)

(21) Appl. No.: 15/910,676

(22) Filed: Mar. 2, 2018

(51) Int. Cl. G06F 3/0484; G06F 17/24; G06F 17/30

(52) U.S. Cl. CPC G06F 3/0484; G06F 17/30864; G06F 17/24

(57) ABSTRACT

A system and method for displaying document revisions. The method includes receiving a collaboratively edited document having revisions made by at least two contributors, gathering document information, and receiving instructions for generating a hierarchically layered view of the document. The method also includes gathering information about the at least two contributors, and calculating trust scores for each of the at least two contributors. Further, the method includes determining that one or more of the contributors have trust scores above a threshold trust score, and automatically generating the hierarchically layered view of the collaboratively edited document in response to this determination. The hierarchically layered view of the collaboratively edited document displays revisions made by at least one of the one or more contributors having trust scores above the threshold trust score.

### BACKGROUND

The present disclosure relates to collaborative document revision and more specifically to the hierarchical display of revisions made by contributors to a document.

Documents (e.g., text documents, graphical images, videos, audio files, etc.) can have more than one contributor. For example, a document can have multiple authors and reviewers. These contributors can use collaborative editing programs to prepare documents. Collaborative editing programs track and display document revisions made by each contributor to a document. For example, revisions such as comments can be displayed in boxes, additions to the document can be highlighted or underlined, and deletions can be crossed out. The contributor responsible for each revision can be identified (e.g., by tagging or coloring). These annotations and changes can then be viewed, annotated, edited, accepted, and/or rejected by other contributors.

### SUMMARY

Various embodiments are directed to a method of displaying document revisions. The method can include receiving a collaboratively edited document having revisions made by at least two contributors, gathering document information from the collaboratively edited document, and receiving instructions for generating a hierarchically layered view of the document. The instructions for generating the hierarchically layered view of the collaboratively edited document can be generated when a number of the at least two contributors is above a threshold number of contributors. The instructions for generating the hierarchically layered view of the collaboratively edited document can also be input by a user. In some embodiments, the collaboratively edited document is a text document. The document can also be a graphical image.

The method can also include gathering contributor information from at least one web source. The contributor information can include connection data and background data. Further, the method can include calculating trust scores for each of the at least two contributors. The trust scores can be based on the contributor information. The method can also include determining that one or more contributors have trust scores above a threshold trust score, and automatically generating the hierarchically layered view of the collaboratively edited document in response to this determination. The hierarchically layered view can display revisions made by at least one of the one or more contributors having trust scores above the threshold trust score.

### BRIEF DESCRIPTION OF THE DRAWINGS

FIG. 1 is a block diagram illustrating a hierarchical layering environment.

FIG. 2 is a flow diagram illustrating a process of generating a hierarchically layered view of a collaboratively edited document.

FIG. 3 is a schematic diagram illustrating an un-layered view of a collaboratively edited document in a word processor display, according to some embodiments of the present disclosure.

FIG. 4 is a schematic diagram illustrating a table of trust scores and a hierarchically layered view of the collaboratively edited document in the word processor display, according to some embodiments of the present disclosure.

FIG. 5 is a block diagram illustrating a computer system, according to some embodiments of the present disclosure.

FIG. 6 is a block diagram illustrating a cloud computing environment, according to some embodiments of the present disclosure.

FIG. 7 is a block diagram illustrating a set of functional abstraction model layers provided by the cloud computing environment, according to some embodiments of the present disclosure.

### DETAILED DESCRIPTION

Documents in a collaborative environment often have more than one contributor. For example, many documents have multiple authors who are involved in the revision of each draft. In addition to these coauthors, documents are frequently edited and/or annotated by one or more reviewers (e.g., peers, subject matter experts, supervisors, copy editors, etc.) before distribution. Collaborative document editing programs provide tools that allow the multiple contributors to revise a single document. These tools track and display revisions made by contributors to a document. In some instances, a different color is assigned to each contributor's revisions. In an example involving a text document, text that has been deleted may be crossed out, and text that has been added may be underlined. Further, comments made by contributors may be displayed in the text document's page margins. The collaborative editing tools allow these revisions to be viewed, annotated, accepted, and rejected by others.

Collaborative editing tools are included in many document creation programs. Examples of these programs can include word processors, spreadsheet programs, presentation programs, PDF file management programs, computer-aided design (CAD) programs, computer graphics software, raster graphics editing programs, vector graphics editing programs, video editing programs, audio editing programs, etc. Software specifically for collaborative editing can also be used, as can web-based collaborative editing programs.

Collaborative editing tools have made it possible for contributors to a document to share comments and revisions more efficiently than was possible before the existence of computers and document editing software. For example, in the past, all revisions to a text document would need to be accomplished by writing notes in ink, having conversations with fellow contributors (e.g., over the telephone, in person, by fax, or by postal mail), writing new drafts, and sharing physical copies of these drafts. Therefore, having multiple contributors review each draft of a document was consuming, and the process was slowed down with each additional contributor. For example, if one contributor hand-wrote comments on a draft, the other contributors would each need to see that copy of the draft. Then, each contributor would need to respond to this draft before a new draft could be written, and the time it would take to finish each draft would depend upon the time it would take the slowest contributor to reply.

However, with collaborative editing software, revisions made by each contributor can be saved to the same draft, which all contributors can simultaneously access and modify through email, online document sharing, or other methods of web communication. This provides increased efficiency that allows a much larger number of contributors to revise a document than was possible prior to the existence of document editing programs and collaborative editing tools. For example, scientific journal articles having hundreds or even thousands of coauthors are becoming increasingly common. However, the collaborative editing tools in document editing programs display revisions made by multiple contributors in a view of a single draft, while identifying the contributors who made each revision (e.g., by different colors or identification labels). A user can typically select revisions made by one or more contributors to display, while the revisions made by others are temporarily concealed. This can make it easier to view a draft that has become cluttered with many revisions.

However, despite the advantages of collaborative editing software, new issues arise when there are large numbers of contributors to a document. The complexity of coordinating multiple contributors, and sorting through the changes, can create bottlenecks in the completion of a document draft. Further, this selection process can lead to inefficiency and inaccuracies. For example, the user must sort through a list of numerous contributors in order to determine which ones to select, which can be time consuming or, in some cases, virtually impossible. Further, the user may be unable to determine which revisions to prioritize, particularly if the user does not have sufficient information about each contributor. For example, a user collaborating on a document with fifteen contributors may only be familiar with two or three of them. Additionally, some of these contributors may make conflicting changes to information presented in the document. In order for the user to determine whose changes to accept, the user would need to know which of the contributors is the most knowledgeable in the subject matter. However, with current collaborative editing tools, the user would have to personally seek out this information by researching the background of each contributor.

A method for automatically prioritizing and hierarchically displaying revisions made by contributors to a collaboratively edited document is disclosed herein. The contributors are automatically prioritized based on information automatically gathered from web sources and the collaboratively edited document. This information includes information about contributors that could not be obtained in a search conducted by a human (e.g., information from social graphs, metadata, large databases, and web sources of which the user is unaware). Additionally, this information is collected and analyzed in larger quantities than would be possible with a manual search. Based on the gathered information, revisions made by automatically selected contributors are displayed according to a hierarchy. The hierarchy of revision layers can be based on various criteria (e.g., occupation, seniority, field of expertise, etc.).

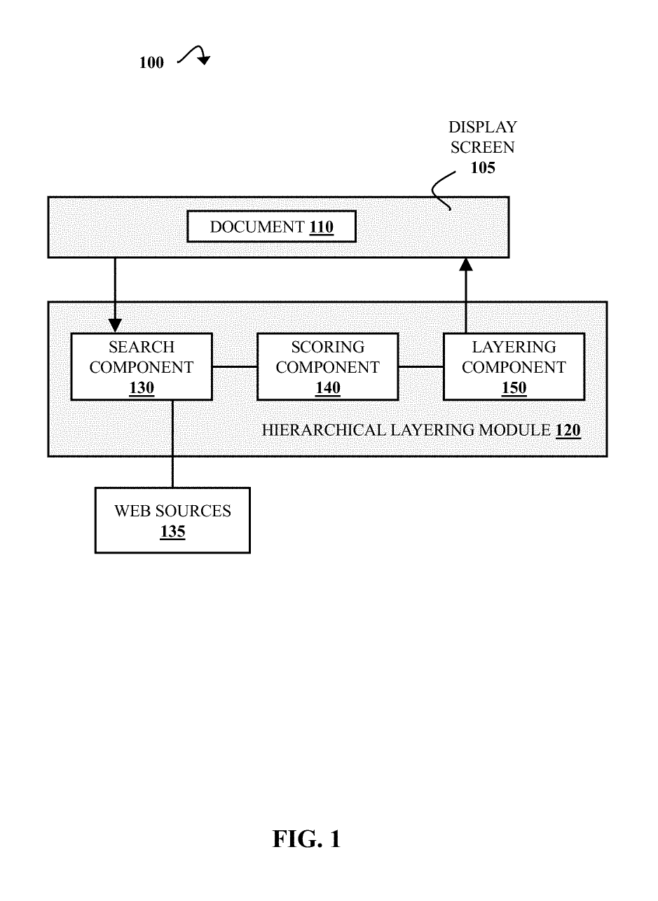

FIG. 1 is a block diagram illustrating a hierarchical layering environment 100. The hierarchical layering environment 100 includes a display screen 105 displaying a collaboratively edited document 110 and a hierarchical layering module 120. The hierarchical layering module 120 includes a search component 130, a scoring component 140, and a layering component 150. A hierarchically layered view of the collaboratively edited document 110 is generated by the hierarchical layering module 120. This is discussed in greater detail below.

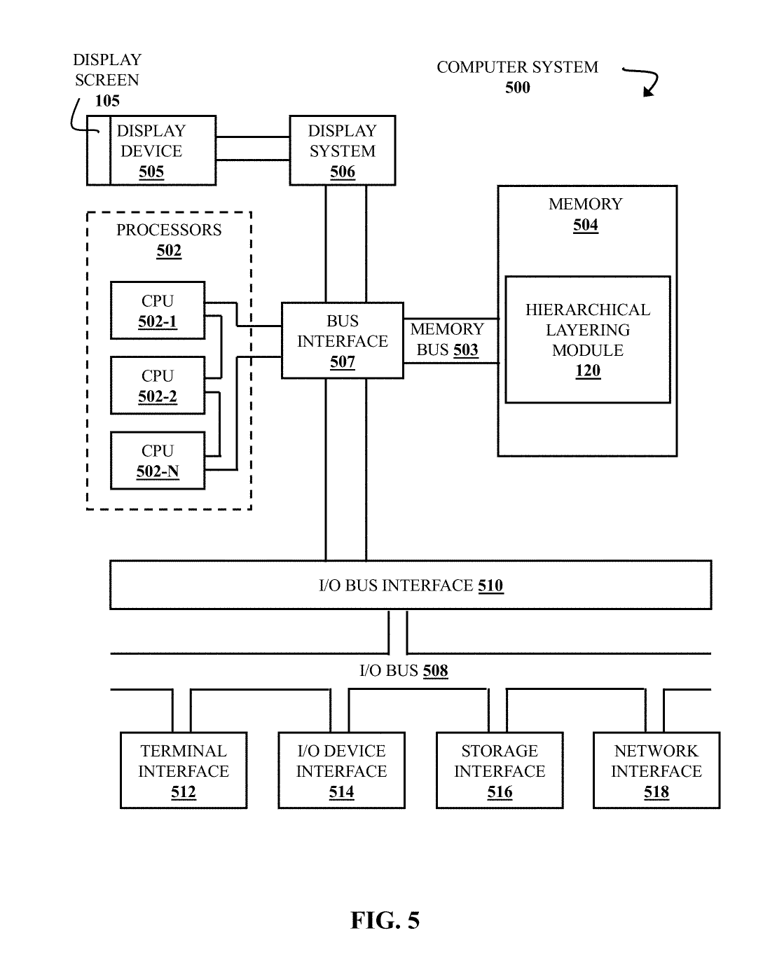

The display screen 105 is part of a device that provides visual, audio, or both types of data. The device is not illustrated in FIG. 1. However, examples of a device such as this can include a desktop computer, a laptop computer, a mobile computing device, a tablet computer, etc. The display screen 105 can also be part of a standalone device (e.g., a computer monitor, television, or handheld device display) connected to a display system. Display devices and systems are discussed in greater detail with respect to FIG. 5. Additionally, the display screen 105 includes a graphical user interface that includes a collaborative editing program for viewing and editing a collaboratively edited document 110.

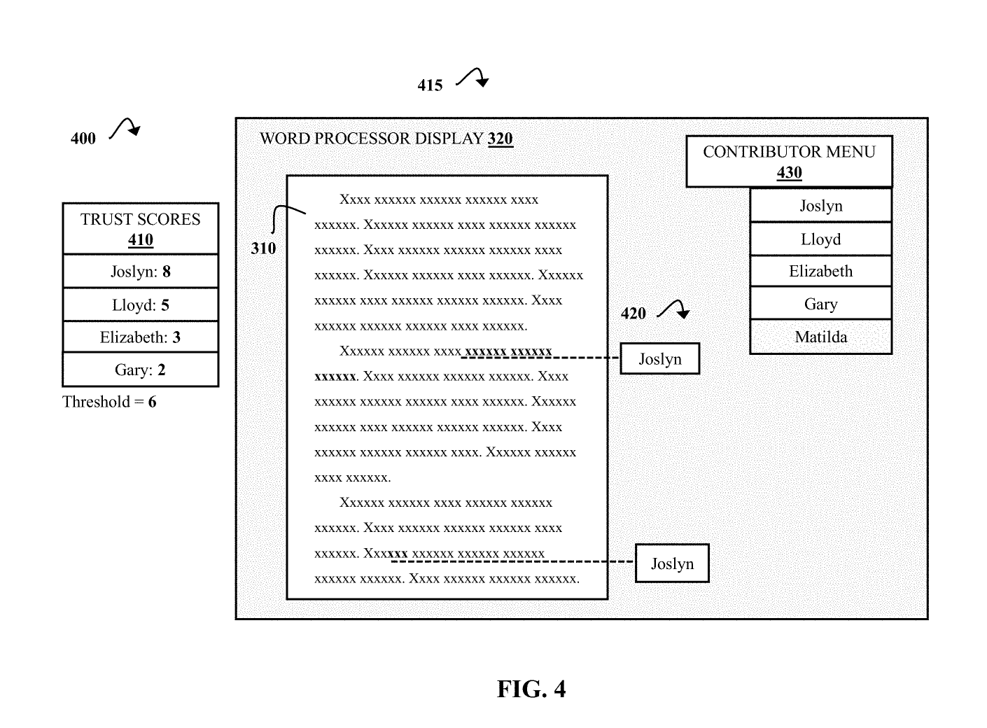

The collaboratively edited document 110 is a document having revisions made by at least two contributors using collaborative editing tools. In some embodiments, the collaboratively edited document 110 is a text document. Examples of collaboratively text documents are discussed in greater detail with respect to FIGS. 4 and 5. However, the collaboratively edited document 110 can be any type of editable document. Additional examples of editable documents can include spreadsheets, graphical images, videos, presentations, portable digital format (PDF) files, audio recordings, and documents that combine two or more of these elements.

The search component 130 of the hierarchical layering module 120 gathers information about the collaboratively edited document 110, as well as contributors to the document 110. This information is gathered from the document 110 itself and from web sources 135. For example, the search component 130 can gather information regarding the number and identities of contributors, instructions for hierarchical layering, and content information (e.g., topic, length, number of revisions, etc.) from the document 110. Examples of gathered information and web sources 135 are discussed in greater detail below.

When the collaboratively edited document 110 includes text data (e.g., letters, numbers, and/or other characters) the search component 130 uses at least one text analysis approach to gather information. For example, key words in the document title or body can be identified, and used to determine what topics are discussed in the document. In some embodiments, text analysis is carried out using natural language processing techniques (e.g., Hidden Markov models, statistical models, decision tree algorithms, supervised machine learning algorithms, semi-supervised machine learning algorithms, unsupervised machine learning algorithms, etc.). Text analysis techniques can also include text mining, naïve B ayes classifiers, latent semantic indexing, etc.

The search component 130 can also use image analysis techniques to gather information from a document 110 that contain images (e.g., graphical images or videos). These techniques can include edge detection techniques, Hidden Markov models, principal component analysis, video fingerprinting, linear discriminant analysis, elastic bunch graph matching, multilinear subspace learning, dynamic link matching, and neural networks. However, any appropriate technique for analyzing images can be used. Additionally, optical character recognition (OCR) can be used to convert characters within an image to text data. This text data can then be analyzed using the aforementioned text analysis approaches.

Further, in documents 110 containing audio data (e.g., recorded or computer-generated audio, such as music, speech, and/or other sounds), the search component 130 can use speech recognition or other semantic audio analysis techniques to obtain document content information. Examples of speech recognition techniques can include Hidden Markov models, dynamic time warping, neural networks, and end-to-end automatic speech recognition. In addition, the search component 130 can use audio fingerprinting algorithms to recognize music or other non-speech audio data. The search component 130 can also use audio analysis techniques in combination with other analyses, such as in a film that includes sound, or in a text document with an embedded audio file.

The search component 130 gathers information about contributors to the document 110 from web sources 135. Data provided by web sources 135 can include social graphs, metadata tags, text data, video or graphical image data, and/or audio data. Examples of web sources 135 include social and professional networking sites, directories (e.g., student, faculty, or company directories), public records databases, professional websites, personal websites, organization membership records, employment records, video hosting sites, blog hosting sites, online purchase histories, and web browsing histories. However, information about contributors can be gathered from any available web sources 135, such as articles written by or about a contributor, photos or videos of a contributor at an event (e.g., a professional conference), and a contributor's profile on a work organization's website.

The search component 130 can use a variety of techniques to gather contributor information from the web sources 135. Examples of these techniques can include text pattern matching, computer vision web page analysis, remote web server requests by hypertext transfer protocol (HTTP) programming, hypertext markup language (HTML) parsing, document object model (DOM) parsing, and semantic annotation recognizing. However, any suitable web content gathering approach can be used. Further, the search component can use the text, image, and audio analysis techniques discussed above to analyze information gathered from web sources 135.

The search component 130 also gathers metadata from the document 110 and web sources 135 in some embodiments. Examples of metadata can include the date and time the document 110 was created, the date and time each draft of the document 110 was saved, the date and time each revision was made, the names of contributors, etc. Metadata for web pages can include the date and time of creation and updates to the web page, names and locations of contributors, identity of the hosting platform, etc. Additionally, the search component 130 can gather document and contributor information that has been entered manually by a user (e.g., into text fields or other input controls in the user interface on the display screen 105) in some embodiments. For example, a graphic designer who creates datasheets for various products may enter information specifying which product each datasheet is for, the members of the team that designed the product, and the type of product.

In some embodiments, contributor profiles containing the gathered contributor information are created by a document editing program. For example, a contributor may log into a document editing program when revising the collaboratively edited document 110. If there are additional contributors to the document 110 who have collaborated on a previous document, and have stored contributor profiles from the previous collaboration, the stored contributor information can be applied to the new document 110. Further, the profile can be updated with any additional contributor information gathered for the new document 110. However, in other embodiments, information in a contributor profile is not used in multiple documents.

The scoring component 140 of the hierarchical layering module 120 calculates trust scores for each contributor to the collaboratively edited document 110 based on the information gathered by the search component 130. These scores are based on contributor information, though document information can be used to adjust the scores. In some embodiments, the scoring component 140 uses statistical methods (e.g., Bayesian networks or hierarchical linear models) to calculate trust scores for the contributors to the document 110. Trust scores can also be calculated using multiple-criteria decision making analysis processes. In some instances, preset scores are assigned to different types of contributor information (e.g., a group leader may always have a score of ten on a scale of one to ten).

In some embodiments, the scoring component 140 bases its calculations on values or weights assigned to contributor information. These values correspond to how closely a user is connected to each contributor (e.g., a direct connection having a higher value than an indirect connection), or the prioritization of selected background data (e.g., subject matter expertise values would increase with increasing contributor credentials in the subject area). A value may also be assigned to each user-contributor connection so that a greater number of connections to one contributor would be valued more highly than a single connection.

In a simple example of a trust score calculation for a document with one user and four additional contributors, connection data gathered from a social graph may indicate that the user is directly connected to each of the four additional contributors on a professional networking site. Based on values assigned to these connections, the four contributors would have identical trust scores. However, additional contributor and document information can be used to adjust the trust scores. For example, additional connection data may be gathered from a reporting chain at a company that employs the user and at least one of the four additional contributors. Values assigned to the company reporting chain connections may correspond to contributors' positions in the reporting chain (e.g., the highest position in the reporting chain corresponding to the highest assigned value). The assigned reporting chain values can also be based on the contributors' positions in relation to the user. Reporting chain positions with no direct or indirect connection to the user may be eliminated, or assigned lower values.

In this example, company reporting chain values are assigned so that the position of the user's direct supervisor has the highest value, the position of the user's peer has a value lower than that of the direct supervisor position, and the position of a junior employee who reports to the user has a lower assigned value than that of the peer. Then, if the company reporting chain indicates that the first of the four contributors is the user's direct supervisor, the second and third contributors are the user's peers, and the fourth contributor is a junior member of a team led by the user, the trust scores may be adjusted so that the first contributor's trust score is the highest, the second and third contributors' trust scores are identical to one another, but lower than that of the first contributor, and the fourth contributor's trust score is the lowest.

Further, background data related to user-contributor relationships can be used to adjust contributors' trust scores. For example, contributor background data gathered from membership records on the website of a professional organization may indicate that the user and the second contributor are both members of the organization. The second contributor's trust score can then be raised so that it is higher than the third contributor's trust score. However, in this example, it is assumed that the value assigned to the organization membership connection is not high enough to raise the second contributor's trust score above that of the first contributor.

Additional background data related to user-contributor connections may indicate that the user and the third contributor have each purchased tickets to the same event through an online ticket vendor. The third contributor's trust score may be raised based on this purchase history connection. However, in this example, it is also assumed that the value assigned to the professional organization membership is higher than the value of the purchase history connection. Therefore, the raised trust score of the third contributor would remain lower than the scores of the first and second contributors, and higher than that of the fourth contributor.

Background data that is related to individual contributors, and does not define connections between the user and the additional contributors can also be incorporated into the trust score calculation. For example, background data may indicate that the third contributor has a higher level of expertise in the document subject matter than the other three contributors. Based on this information, the trust score of the third contributor may be increased again. In this example, it is assumed that the subject matter expertise value is high enough to raise the trust score of the third contributor above that of the second contributor, but not that of the first contributor. Therefore, the order of the four contributors in this example, from highest to lowest trust score, would be first, third, second, and fourth.

In some embodiments, the scoring component 140 can adjust the trust score based on document information. For example, if one contributor's revisions are the most frequently retained in saved drafts of the document 110, this contributor's trust score may be increased. In addition, if a contributor is found to make substantial revisions to the document 110, this may also lead to a raised trust score. Examples of substantial revisions may include adding numerous comments and rewriting entire paragraphs. Less substantial revisions may include minor grammatical corrections (e.g., a small number of deleted commas). The topic of the document may also be used to adjust the trust score. For example, a user's work supervisor may have a higher trust score in a business document (e.g., a product datasheet) than an academic document (e.g., an essay describing early agrarian societies).

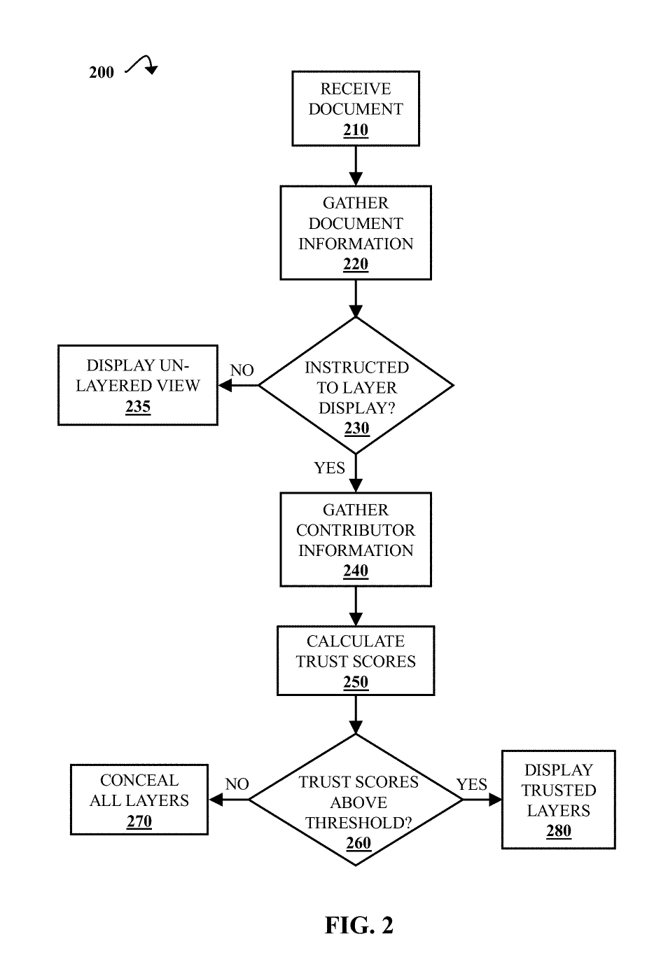

The layering component 150 generates a hierarchically layered view of the collaboratively edited document 110. The layering component 150 determines a hierarchy of revision layers for the hierarchically layered view based on the trust scores calculated by the scoring component 140. The layering component 150 determines whether there are contributors to the collaboratively edited document who have trust scores above a trust score threshold. Trust score thresholds are discussed in greater detail with respect to FIG. 2. The layering component 150 also determines which revision layers to automatically display in the hierarchically layered view of the document 110. If there is at least one contributor with a trust score above the trust score threshold, the layering component 150 automatically displays at least one revision layer of these contributors in the hierarchically layered view. The layering component 150 can also generate a view of the document 110 wherein all revision layers are concealed. For example, if there are no contributors with trust scores over the trust score threshold, the layering component 150 does not automatically display any revision layers.

In some embodiments, the hierarchically layered view generated by the layering component 150 also displays or conceals revision layers based on user selections. These layers can be selected by the user through a menu in the graphical user interface of the display screen 105. For example, the hierarchically layered view generated by the layering component 150 can include a menu displaying the names of the contributors and/or other contributor information. Contributor menus are discussed in greater detail with respect to FIGS. 2 and 4. The user can select revision layers from this menu, thereby directing the layering component 150 to display the selected layers in the hierarchically layered view of the document 110. The user can also unselect a revision layer, causing the revision layer to be concealed.

FIG. 2 is a flow diagram illustrating a process 200 of generating a hierarchically layered view of a collaboratively edited document. To illustrate process 200, but not to limit embodiments, FIG. 2 is described within the context of the hierarchical layering environment 100 of FIG. 1. Where elements shown in FIG. 2 are identical to elements shown in FIG. 1, the same reference numbers are used in both Figures.

Process 200 begins when the collaboratively edited document 110 is received. This is illustrated at step 210. The collaboratively edited document 110 is viewed and edited by a user through a graphical user interface on the display screen 105. Herein, “user” refers to an individual who is currently viewing and/or contributing to the collaboratively edited document (e.g., an author or reviewer). Individuals other than the user who have contributed to the received document (e.g., coauthors and/or fellow reviewers) are referred to as additional contributors. In some embodiments, the received document 110 displays revisions made by all contributors. However, the collaboratively edited document 110 can also be received with all document revisions concealed. Further, in some embodiments, only revision layers that have been selected by a user (e.g., by clicking on a contributor name in a dropdown menu) are displayed.

Document information is gathered from the received collaboratively edited document 110 by the search component 130 of the hierarchical layering module 120. This is illustrated at step 220. In some embodiments, document information can be entered by a user as well. The document information includes the number and identities of contributors, and can also include information about the document revisions, such as the number of revisions, types of revisions (e.g., text addition or removal, grammar corrections, annotations, etc.), and/or the date and time of revisions. The document information can also include information about the content of the document 110. Examples of document content information include subject matter, field or industry (e.g., product design, architecture, journalism, scientific research, etc.), number of misspellings and grammatical errors, language or dialect, writing style (e.g., technical, prose, poetry, etc.), date of creation or modification, and/or number of saved versions.

From the document information, it is determined whether there are instructions for generating a hierarchically layered view of the collaboratively edited document 110. This is illustrated at step 230. The layering component 150 of the hierarchical layering module 120 makes this determination based on information gathered by the search component 130. A hierarchically layered view is a view of the document 110 that displays selected contributors' revisions in layers according to a ranking (i.e., a hierarchy). Each revision layer corresponds to a single contributor, and the layering component 150 automatically selects revision layers for display based on a prioritization of their corresponding contributors. Instructions for generating the hierarchically layered view of the document 110 can be generated in response to a variety of triggers.

One example of a trigger for generating these instructions is the number of contributors to the document 110. In some embodiments, instructions for generating the hierarchically layered view are generated when the number of contributors surpasses a threshold number of contributors (referred to herein as a contributor threshold). For example, if a contributor threshold is three contributors, instructions for generating a hierarchically layered view would be triggered when there are three or more contributors to the document 110. However, the contributor threshold can be any number of contributors, such as 5, 10, 50, or 100 contributors. The hierarchical layering module can include a preset contributor threshold, but the contributor threshold can also be input or adjusted by a user in some embodiments.

Instructions for generating the hierarchically layered view can also be generated when the number of revisions to the document 110 is above a threshold quantity of document revisions (referred to herein as a revision threshold), such as an average number of revisions per page. For example, the instructions may be generated if the document 110 has an average of ten or more revisions per page. The revision threshold can also be a total number of revisions made to the document 110. Further, the revision threshold can be an average number of revisions per contributor. However, any approach to the quantification of document revisions can be used, such as determining the percentage of document area at the user interface occupied by displayed revisions (e.g., comment boxes covering 50% of an image), or considering both the quantity and type of revisions (e.g., a large number of minor revisions and a small number of major revisions may both be above the same revision threshold). Additionally, the revision threshold and contributor threshold can both be used in some embodiments. For example, instructions for generating the hierarchically layered view may be generated when both the number of contributors and the number of revisions per contributor are above their respective thresholds.

Instructions for generating the hierarchically layered view of the collaboratively edited document 110 can also be input by a user in some embodiments. In these instances, the user inputs the instructions through the user interface on the display screen 105 by selecting a hierarchical layering option. The user may make this selection by checking a box, selecting a menu item such as an icon or text, or adjusting the contributor threshold so that it is a number below a current or expected number of contributors to the document. Similarly, the user can manually cancel the generation of the hierarchically layered view by selecting an option to do so, or by unselecting an option for generating the hierarchically layered view.

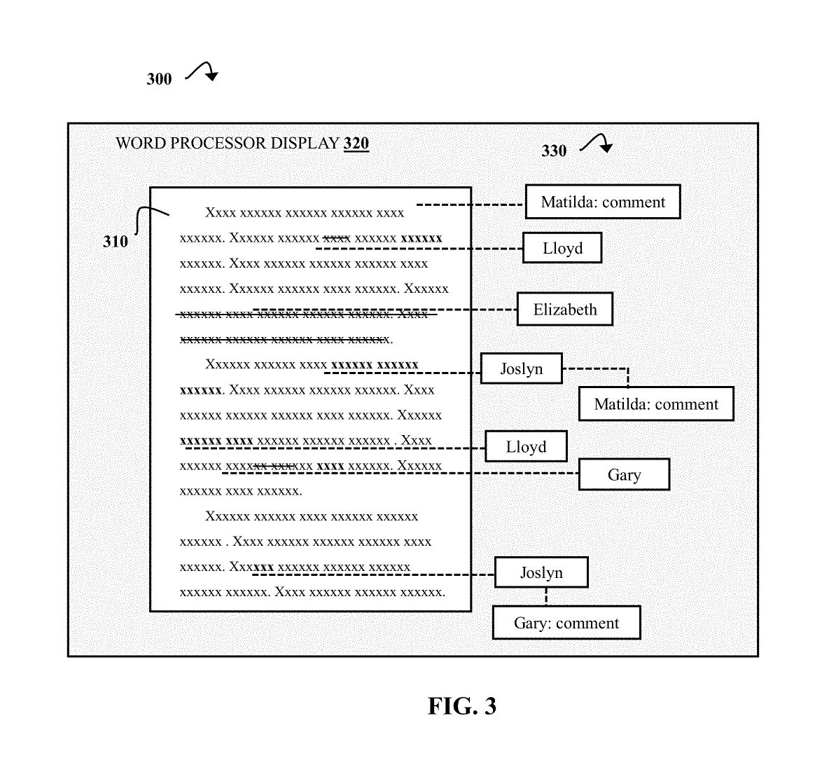

If it is determined at step 230 that there are no instructions for generating a hierarchically layered view of the collaboratively edited document 110, the layering module 150 makes no changes to the document view. Instead, the collaboratively edited document is displayed as it was initially received. This is illustrated at step 235. Herein, a view of the collaboratively edited document 110 as it was initially received at step 210 is referred to as an “un-layered view”. The un-layered view can display all revisions, no revisions, or a portion of the revisions. An example of an-layered view of a collaboratively edited text documents is discussed in greater detail with respect to FIG. 3.

If it is instead determined at step 230 that there are instructions for generating a hierarchically layered view of the collaboratively edited document 110, information about the contributors is gathered by the search component 130 of the hierarchical layering module 120. This is illustrated at step 240. The search component 130 gathers contributor information from web sources 135. In some embodiments, the document information gathered by the search component 130 from the collaboratively edited document 110 includes contributor information as well. In some embodiments, contributor information is gathered for both the user and each additional contributor. However, in other embodiments, contributor information is only gathered for some or all of the additional contributors.

The contributor information can be categorized into connection data and background data. Connection data identifies relationships (e.g., coworkers, classmates, friends, etc.) between the user and the additional contributors. The connection data also indicates how closely connected the user is to each contributor (e.g., directly connected or indirectly connected by a number of degrees). Background data includes information about individual contributors (e.g., job titles, areas of expertise, years of experience, etc.). In some embodiments, the search component 130 gathers both connection and background data. However, in other embodiments, the search component 130 gathers only connection data or only background data. The types of data gathered can also vary amongst the individual contributors, such as when both connection and background data are available for some contributors, but only one or the other is available for other contributors.

In some embodiments, the search component 130 gathers connection data from web sources 135 that include at least one social graph. A social graph is a representation of connections between individuals. Sources of social graph information include social and professional networking services. From a social graph, the distance between two connected individuals can be determined. The distance between a pair of individuals in a social graph refers to the degrees of separation between the two. If a user and at least two additional contributors to the collaboratively edited document 110 are found in a social graph, the distances between the user and each additional contributor can be compared. For example, the social graph may indicate that the user is directly connected to a first contributor, and is connected to a second contributor by two degrees of separation. In addition to the social graphs, connection data can be gathered from company reporting chains, photographs that include both a user and another contributor, organization membership records, or any other record of relationships between individuals.

In another example, contributor information is gathered from the collaboratively edited document 110 in addition to the web sources 135. For example, the document 110 may be an article written by multiple authors, and organized into three different sections, each section covering a different topic. Analysis of the text (e.g., by natural language processing techniques) and/or metadata may indicate which contributors contributed most to each section. For example, each section may have been written by a single contributor. Certain reviewers may also have made the majority of their revisions to particular sections. The reviewers and coauthors who contributed most to each section may be considered to have greater expertise in the subject area covered by that section.

A trust score is then calculated for each contributor to the document 110. This is illustrated at step 250. The trust scores are calculated by the scoring component 140 of the hierarchical layering module 120, and are based on the contributor information gathered by the search component 130. In some embodiments, trust scores are based solely on connections between a user and additional contributors. Additionally, trust scores can be based on background data about each contributor. However, in some embodiments, trust scores are based on a combination of connection and background data. Examples of trust score calculations are discussed in greater detail with respect to FIG. 1.

When trust scores have been calculated for the contributors, the layering component 150 of the hierarchical layering module 120 determines whether there is at least one trust score above a threshold trust score. This is illustrated at step 260. The threshold trust score can be preset and/or input by a user. For example, a preset threshold trust score could be 5. If the trust scores of a first, second, third, and fourth contributor are 8, 6, 7, and 4, respectively, it would be determined that there is at least one trust score above the threshold trust score of 5. However, if the respective trust scores are instead 5, 2, 3, and 1, it would be determined that there are no trust scores above the threshold trust score.

In some embodiments, the threshold trust score can be adjusted based on user preference. The threshold scores can be presented numerically (e.g., scores 1-10), or as threshold levels. For example, a user could select between levels one and two, where level one has a lower threshold trust score than level two. The threshold levels can be expressed in a variety of ways, and can be selected or entered using input controls in a user interface. In some embodiments, the trust score threshold levels can be expressed as words, letters, percentages, numbers, colors, and/or icons. However, it should be noted that, in some embodiments, the threshold trust score cannot be adjusted by a user.

If there are no trust scores above the threshold trust score, the revision layers of all contributors are concealed in the document view. This is illustrated at step 270. More specifically, the layering component 150 does not automatically display any of the revision layers when there are no trust scores above this threshold. However, some or all of the revisions can be displayed if the user selects an option for viewing one or more revision layers (e.g., a menu item such as an icon, checkbox, or selectable text). The user can select an option for displaying all revision layers in some embodiments. The user can also choose an option to display revision layers based on desired criteria. For example, the user can select revision layers by contributor identity, contributor trust score, or background data. The user may choose these revisions layers from a contributor selection menu or separate window that includes each contributor's name, job, connection to the user, calculated trust score, or other information.

If at least one trust score is above the threshold trust score, the layering component 150 generates a hierarchically layered view of the collaboratively edited document 110. This is illustrated at step 280. In this view, the layering component 150 automatically displays at least one revision layer of a contributor with a trust score above the threshold trust score. In some embodiments, revision layers of all contributors with trust scores above the threshold trust score are displayed in the hierarchically layered view. However, in some instances, the revision layer corresponding to the highest trust score is the only layer automatically displayed. Preset or user input settings can specify which of the revision layers of contributors with trust scores above the threshold trust score are automatically displayed. Additionally, a menu hierarchically (e.g., in descending order of trust score) displaying the names or other identifiers, such as titles (e.g., professor, tutor, manager, etc.) or categories (e.g., colleagues, classmates, friends, etc.), of the additional contributors can optionally be generated. The user can select contributors from this menu in order to add their revisions to the hierarchically layered view.

FIG. 3 is a schematic diagram illustrating an un-layered view 300 of a collaboratively edited text document 310 in a word processor display 320, according to some embodiments of the present disclosure. The collaboratively edited text document 310 includes revisions 330 made by five contributors. The contributors include two coauthors, Matilda and Lloyd, and three reviewers, Elizabeth, Joslyn, and Gary. In this un-layered view 300, all revisions 330 are displayed, and are labeled with the names of their corresponding contributors. The un-layered view 300 of the text document 310 can be converted into a hierarchically layered view by carrying out steps in process 100. Generating the hierarchically layered view of the text document 310 reduces the number of visible revisions according to a prioritization of contributors. A hierarchically layered view of the text document 310 is discussed greater detail with respect to FIG. 4.

FIG. 4 is a schematic diagram illustrating a table 400 of trust scores 410 and a hierarchically layered view 415 of the collaboratively edited text document 310 in the word processor display 320, according to some embodiments of the present disclosure. The trust scores 410 of Joslyn, Lloyd, Elizabeth, and Gary are 8, 5, 3, and 2, respectively. Matilda does not have a trust score because, in this example, she is the user currently viewing the document. The trust scores 410 of the additional contributors are calculated based, at least in part, on their connections to Matilda (e.g., the relative distances between Matilda and each additional contributor in a social graph). A preset threshold trust score of 6 is noted at the bottom of table 400. Of the contributors' trust scores, only Joslyn's trust score of 8 is above the threshold score. Therefore, only Joslyn's revision layer 420 has been automatically displayed in the hierarchically layered view 415 of the text document 310.

However, the word processor display 320 includes a contributor menu 430 having selectable boxes for the revision layers of each contributor. One or more boxes can be selected in order to display or conceal revision layers for the corresponding contributors. For example, if Matilda selects the box labeled “Lloyd”, the layer with Lloyd's revisions will be displayed. The hierarchy of the contributor menu 430 is based on the contributor trust scores 410, and the boxes are placed in descending order of trust score 410. In some embodiments, the menu 430 is automatically generated. However, the menu 430 can also be generated in response to a user command. Matilda's name is at the bottom of the list because she is the current user. However, her name could also elsewhere on the list (e.g., the top), displayed in a location other than the menu 430, or not displayed.

In some embodiments, information about contributors can be displayed in response to the selection of the corresponding boxes on the contributor menu 430. In one example, Matilda may access information about Elizabeth (e.g., her trust score, area of expertise, distance in a social graph, etc.) by hovering a cursor over the box labeled “Elizabeth”. In another example, a pop-up window containing information about Elizabeth may appear when Matilda clicks on the “Elizabeth” box. A contributor information display option may also be selected from another menu (not shown) in the word processor display 320. Further, in some embodiments, contributor information is not available for display.

FIG. 5 is a high-level block diagram illustrating an exemplary computer system 500 that can be used in implementing one or more of the methods, tools, components, and any related functions described herein (e.g., using one or more processor circuits or computer processors of the computer). In some embodiments, the major components of the computer system 500 comprise one or more processors 502, a memory subsystem 504, a terminal interface 512, a storage interface 516, an input/output device interface 514, and a network interface 518, all of which can be communicatively coupled, directly or indirectly, for inter-component communication via a memory bus 503, an input/output bus 508, bus interface unit 507, and an input/output bus interface unit 510.

The computer system 500 contains one or more general-purpose programmable central processing units (CPUs) 502-1, 502-2, and 502-N, herein collectively referred to as the CPU 502. In some embodiments, the computer system 500 contains multiple processors typical of a relatively large system; however, in other embodiments the computer system 500 can alternatively be a single CPU system. Each CPU 502 may execute instructions stored in the memory subsystem 510 and can include one or more levels of on-board cache.

The memory 504 can include a random-access semiconductor memory, storage device, or storage medium (either volatile or non-volatile) for storing or encoding data and programs. In some embodiments, the memory 504 represents the entire virtual memory of the computer system 500, and may also include the virtual memory of other computer systems coupled to the computer system 500 or connected via a network. The memory 504 is conceptually a single monolithic entity, but in other embodiments the memory 504 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory can be further distributed and associated with different CPUs or sets of CPUs, as is known in any of various so-called non-uniform memory access (NUMA) computer architectures. The memory 504 also contains a hierarchical layering module 120, which includes a search component 130, a scoring component 140, and a layering component 150. The hierarchical layering module is discussed in greater detail with respect to FIG. 1.

These components are illustrated as being included within the memory 504 in the computer system 500. However, in other embodiments, some or all of these components may be on different computer systems and may be accessed remotely, e.g., via a network. The computer system 500 may use virtual addressing mechanisms that allow the programs of the computer system 500 to behave as if they only have access to a large, single storage entity instead of access to multiple, smaller storage entities. Thus, though the hierarchical layering module 120 is illustrated as being included within the memory 504, components of the memory 504 are not necessarily all completely contained in the same storage device at the same time. Further, although these components are illustrated as being separate entities, in other embodiments some of these components, portions of some of these components, or all of these components may be packaged together.

In an embodiment, the hierarchical layering module 120 includes instructions that execute on the processor 502 or instructions that are interpreted by instructions that execute on the processor 502 to carry out the functions as further described in this disclosure. In another embodiment, the hierarchical layering module 120 is implemented in hardware via semiconductor devices, chips, logical gates, circuits, circuit cards, and/or other physical hardware devices in lieu of, or in addition to, a processor-based system. In another embodiment, the hierarchical layering module 120 includes data in addition to instructions.

Although the memory bus 503 is shown in FIG. 5 as a single bus structure providing a direct communication path among the CPUs 502, the memory subsystem 510, the display system 506, the bus interface 507, and the input/output bus interface 510, the memory bus 503 can, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the input/output bus interface 510 and the input/output bus 508 are shown as single respective units, the computer system 500 may, in some embodiments, contain multiple input/output bus interface units 510, multiple input/output buses 508, or both. Further, while multiple input/output interface units are shown, which separate the input/output bus 508 from various communications paths running to the various input/output devices, in other embodiments some or all of the input/output devices may be connected directly to one or more system input/output buses.

The computer system 500 may include a bus interface unit 507 to handle communications among the processor 502, the memory 504, a display system 506, and the input/output bus interface unit 510. The input/output bus interface unit 510 may be coupled with the input/output bus 508 for transferring data to and from the various input/output units. The input/output bus interface unit 510 communicates with multiple input/output interface units 512, 514, 516, and 518, which are also known as input/output processors (IOPs) or input/output adapters (IOAs), through the input/output bus 508. The display system 506 may include a display controller. The display controller may provide visual, audio, or both types of data to a display device 505, which includes a display screen 105 for viewing a collaboratively edited document 110. The display system 506 may be coupled with a display device 505, such as a standalone display screen, computer monitor, television, or a tablet or handheld device display. In alternate embodiments, one or more of the functions provided by the display system 506 may be on board a processor 502 integrated circuit. In addition, one or more of the functions provided by the bus interface unit 507 may be on board a processor 502 integrated circuit.

In some embodiments, the computer system 500 is a multi-user mainframe computer system, a single-user system, or a server computer or similar device that has little or no direct user interface, but receives requests from other computer systems (clients). Further, in some embodiments, the computer system 500 is implemented as a desktop computer, portable computer, laptop or notebook computer, tablet computer, pocket computer, telephone, smart phone, network switches or routers, or any other appropriate type of electronic device.

It is noted that FIG. 5 is intended to depict the representative major components of an exemplary computer system 500. In some embodiments, however, individual components may have greater or lesser complexity than as represented in FIG. 5, Components other than or in addition to those shown in FIG. 5 may be present, and the number, type, and configuration of such components may vary.

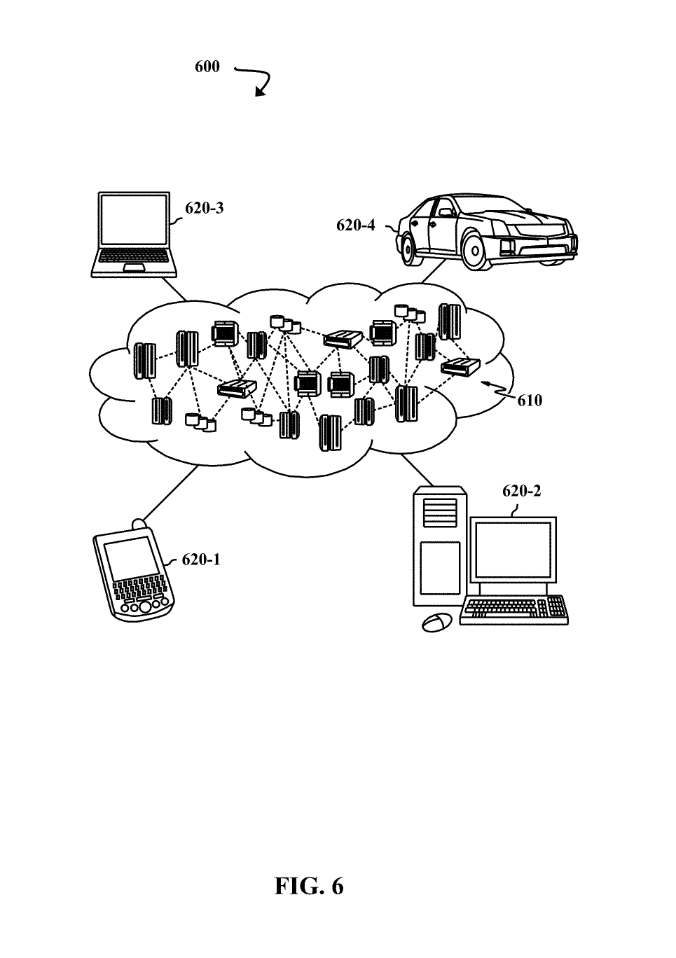

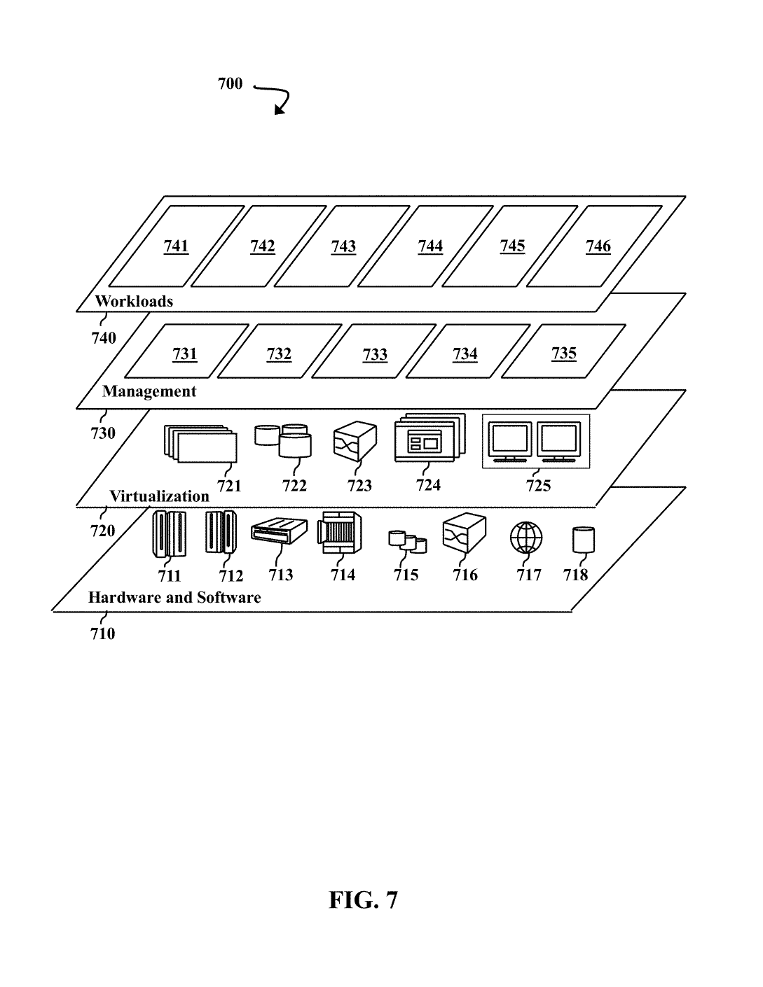

In some embodiments, the data storage and retrieval processes described herein could be implemented in a cloud computing environment, which is described below with respect to FIGS. 6 and 7. It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as Follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

FIG. 6 is a block diagram illustrating a cloud computing environment 600, according to some embodiments of the present disclosure. As shown, cloud computing environment 600 includes one or more cloud computing nodes 610 with which local computing devices used by cloud consumers, such as, for example, personal digital assistant (PDA) or cellular telephone 620-1, desktop computer 620-2, laptop computer 620-3, and/or automobile computer system 620-4 may communicate. Nodes 610 may communicate with one another. They may be grouped (not shown) physically or virtually, in one or more networks, such as Private, Community, Public, or Hybrid clouds as described hereinabove, or a combination thereof. This allows cloud computing environment 600 to offer infrastructure, platforms and/or software as services for which a cloud consumer does not need to maintain resources on a local computing device. It is understood that the types of computing devices 620-1-620-4 shown in FIG. 6 are intended to be illustrative only and that computing nodes 610 and cloud computing environment 600 can communicate with any type of computerized device over any type of network and/or network addressable connection (e.g., using a web browser).

FIG. 7 is a block diagram illustrating a set of functional abstraction model layers 700 provided by the cloud computing environment 600, according to some embodiments of the present disclosure. It should be understood in advance that the components, layers, and functions shown in FIG. 7 are intended to be illustrative only and embodiments of the invention are not limited thereto. As depicted, the following layers and corresponding functions are provided:

Hardware and software layer 710 includes hardware and software components. Examples of hardware components include: mainframes 711; RISC (Reduced Instruction Set Computer) architecture-based servers 712; servers 713; blade servers 714; storage devices 715; and networks and networking components 716. In some embodiments, software components include network application server software 717 and database software 718.

Virtualization layer 720 provides an abstraction layer from which the following examples of virtual entities may be provided: virtual servers 721; virtual storage 722; virtual networks 723, including virtual private networks; virtual applications and operating systems 724; and virtual clients 725.

In one example, management layer 730 provides the functions described below. Resource provisioning 731 provides dynamic procurement of computing resources and other resources that are utilized to perform tasks within the cloud computing environment. Metering and Pricing 732 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 733 provides access to the cloud computing environment for consumers and system administrators. Service level management 734 provides cloud computing resource allocation and management such that required service levels are met. Service Level Agreement (SLA) planning and fulfillment 735 provide pre-arrangement for, and procurement of, cloud computing resources for which a future requirement is anticipated in accordance with an SLA.

Workloads layer 740 provides examples of functionality for which the cloud computing environment can be utilized. Examples of workloads and functions that can be provided from this layer include: mapping and navigation 741; software development and lifecycle management 742; virtual classroom education delivery 743; data analytics processing 744; transaction processing 745; and generating hierarchically layered views of collaboratively edited documents 746.

The present disclosure may be a system, a method, and/or a computer program product. The computer program product may include a computer readable storage medium (or media) having computer readable program instructions thereon for causing a processor to carry out aspects of the present disclosure.

The computer readable storage medium is a tangible device that can retain and store instructions for use by an instruction execution device. Examples of computer readable storage media can include an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network can comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a component, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present disclosure has been described in terms of specific embodiments, it is anticipated that alterations and modification thereof will become apparent to the skilled in the art. Therefore, it is intended that the following claims be interpreted as covering all such alterations and modifications as fall within the true spirit and scope of the present disclosure.

What is claimed is:

1. A method, implemented by a computer processor, of displaying document revisions, comprising:
receiving a collaboratively edited document having revisions made by at least two contributors;
gathering document information from the collaboratively edited document;
receiving instructions for generating a hierarchically layered view of the collaboratively edited document;
gathering contributor information in response to receiving the instructions;
calculating trust scores for the at least two contributors;
determining that one or more contributors of the at least two contributors have trust scores above a threshold trust score; and
automatically generating the hierarchically layered view of the collaboratively edited document in response to determining, wherein the hierarchically layered view displays revisions made by at least one of the one or more contributors having trust scores above the threshold trust score.

2. The method of claim 1, wherein the instructions for generating the hierarchically layered view of the collaboratively edited document are generated when a number of the at least two contributors is above a threshold number of contributors.

3. The method of claim 1, wherein the instructions for generating the hierarchically layered view of the collaboratively edited document are input by a user.

4. The method of claim 1, wherein the contributor information includes connection data.

5. The method of claim 1, wherein the contributor information includes background data.

6. The method of claim 1, wherein the contributor information is gathered from at least one web source.

7. The method of claim 1, wherein the trust scores are based on the contributor information.

8. The method of claim 1, wherein the collaboratively edited document is a text document.

9. The method of claim 1, wherein the collaboratively edited document includes a graphical image.

10. A system, comprising:
at least one processing component;
at least one memory component;
a display screen displaying a collaboratively edited document having revisions made by at least two contributors; and
a hierarchical layering module, comprising:
a search component configured to:
gather document information from the collaboratively edited document; and
gather contributor information when there are instructions for generating a hierarchically layered view of the collaboratively edited document;
a scoring component configured to calculate trust scores for the at least two contributors; and
a layering component configured to:
determine that one or more contributors of the at least two contributors have trust scores above a threshold trust score; and
automatically generate the hierarchically layered view of the collaboratively edited document, wherein the hierarchically layered view displays revisions made by at least one of the one or more contributors having trust scores above the threshold trust score.

11. The system of claim 10, wherein the contributor information includes both connection data and background data.

12. The system of claim 10, wherein the scoring component calculates the trust scores based on the contributor information.

13. The system of claim 10, wherein the search component gathers the contributor information from at least one web source selected from a group consisting of social networking sites, professional networking sites, directories, public records databases, company reporting chains, organization membership records, professional websites, personal websites, employment records, video hosting sites, online purchase history, and web browsing history.

14. The system of claim 10, wherein the search component gathers the document information using natural language processing techniques.

15. The system of claim 10, wherein the search component gathers the document information using techniques selected from a group consisting of edge detection techniques, Hidden Markov models, principal component analysis, video fingerprinting, linear discriminant analysis, elastic bunch graph matching, multilinear subspace learning, dynamic link matching, and neural networking.

16. A computer program product for displaying document revisions, the computer program product comprising a computer readable storage medium having program instructions embodied therewith, the program instructions executable by a processor to cause the device to perform a method, the method comprising:
receiving a collaboratively edited document having revisions made by at least two contributors;
gathering document information from the collaboratively edited document;
receiving instructions for generating a hierarchically layered view of the collaboratively edited document;
gathering contributor information in response to receiving the instructions;
calculating trust scores for each of the at least two contributors;
determining that one or more contributors of the at least two contributors have trust scores above a threshold trust score; and
automatically generating the hierarchically layered view of the collaboratively edited document in response to the determining, wherein the hierarchically layered view displays revisions made by at least one of the one or more contributors having trust scores above the threshold trust score.

17. The computer program product of claim 16, wherein the contributor information includes both connection data and background data.

18. The computer program product of claim 16, wherein the connection data includes a distance from a user in a social graph.

19. The computer program product of claim 16, wherein the connection data includes a position in a company reporting chain.

20. The computer program product of claim 16, wherein the background data is an area of expertise.
